(19) United States
(12) Patent Application Publication
(10) Pub. No.: US 2013/0278521 A1
(43) Pub. Date: Oct. 24, 2013

(54) TOUCH PANEL AND METHOD OF MANUFACTURING THE SAME

(71) Applicant: SAMSUNG ELECTRONICS CO., LTD., Suwon-si (KR)

(72) Inventor: Hakyeol KIM, Hwaseong-si (KR)

(73) Assignee: Samsung Electronics Co., Ltd., Suwon-si (KR)

(21) Appl. No.: 13/866,684

(22) Filed: Apr. 19, 2013

(30) Foreign Application Priority Data
Apr. 23, 2012 (KR) 10-2012-0041883

(51) Int. Cl. G06F 3/041

(52) U.S. Cl. CPC G06F 3/0412
USPC 345/173; 427/97.4; 156/60

(57) ABSTRACT

A touch panel using a conductive mesh and a method of manufacturing the same are provided. The touch panel includes a substrate on which a conductive mesh is disposed, a plurality of driving channels for recognizing a horizontal axis coordinate, wherein the plurality of driving channels are formed by patterning a first conductive mesh disposed on the substrate, a plurality of sensing channels for recognizing a vertical axis coordinate, wherein the sensing channels are formed by patterning a second conductive mesh disposed on the substrate, and an insulating layer positioned between the first conductive mesh and the second conductive mesh.

### PRIORITY

This application claims the benefit under 35 U.S.C. §119(a) of a Korean patent application filed on Apr. 23, 2012 in the Korean Intellectual Property Office and assigned Serial No. 10-2012-0041883, the entire disclosure of which is hereby incorporated by reference.

### BACKGROUND OF THE INVENTION

1. Field of the Invention

The present invention relates to a touch panel and a method of manufacturing the same. More particularly, the present invention relates to a touch panel using a conductive mesh and a method of manufacturing the same.

2. Description of the Related Art

Nowadays, due to convenience to input data into an apparatus, interest has increased in a touch screen. The touch screen is formed by attaching a touch panel at a front surface of a display panel. That is, the touch screen can perform an input function and a display function. Particularly, nowadays, interest has increased in a multi-touch panel that can simultaneously recognize a plurality of touches.

FIGS. 1 and 2 are diagrams illustrating a touch panel according to the related art.

Referring to FIG. 1, a touch panel 100 includes a plurality of driving channels 10 for recognizing a horizontal axis coordinate and a plurality of sensing channels 20 for recognizing a vertical axis coordinate. To prevent the driving channel 10 and the sensing channel 20 of the touch panel 100 from contacting each other, the driving channel 10 and the sensing channel 20 are stacked at different substrates 1 and 2 to have a predetermined separation distance. That is, the touch panel 100 has a 2-layer structure.

In such a touch panel 100, the driving channel 10 and the sensing channel 20 cross at a plurality of points, as shown in FIG. 1. For example, when the driving channels 10 are 6 in number, and the sensing channels 20 are 5 in number, the touch panel 100 has 30 crossing points. In this case, when it is assumed that a width of the driving channel 10 is 4 mm and a width of the sensing channel 20 is 1 mm, each crossing point of the touch panel 100 has an area of 4 mm².

The touch panel 100 operates by Equation 1.

capacitance C=(dielectric constant*crossing area)/separation distance Equation 1

That is, in order to obtain the same performance (value C), when an area of a crossing point (crossing area) of the driving channel 10 and the sensing channel 20 increases, the touch panel 100 should increase a separation distance. Further, as a dielectric constant between the driving channel 10 and the sensing channel 20 increases, the separation distance should be increased. For example, when producing a touch panel having the same performance as that of a touch panel in which the driving channel 10 and the sensing channel 20 are formed at a separation distance of 0.2 mm using a PET film having a dielectric constant of 3.5 using glass having a dielectric constant of 7, the separation distance should be 0.4 mm.

In general, in the touch panel 100, the driving channel 10 and the sensing channel 20 are formed using Indium Tin Oxide (ITO). However, when using ITO, a technical limitation exists in reducing a crossing area of the driving channel 10 and the sensing channel 20. This is because when a width of the driving channel 10 and the sensing channel 20 is excessively reduced, resistance of the driving channel 10 and the sensing channel 20 increases and thus a touch signal cannot be smoothly transmitted. That is, as shown in FIG. 1, in the touch panel 100 having a 2-layer structure, it is difficult to reduce a thickness (separation distance) while maintaining a touch performance. Particularly, when using a substrate having a large dielectric constant, it is difficult to reduce a separation distance in the touch panel 100.

Another example of a touch panel 200 is shown in FIG. 2. The touch panel 200 has a 1-layer double pattern structure that forms a driving channel 15 and a sensing channel 25 in one substrate. In this case, the touch panel 200 has an insulating layer 45 at a crossing point of the driving channel 15 and the sensing channel 25. In this way, since the driving channel 15 and the sensing channel 25 are formed in one layer, the touch panel 200 has a structure with a very small separation distance. Therefore, to prevent a touch performance from deteriorating, a crossing area of the driving channel 15 and the sensing channel 25 should be minimized. Accordingly, a resistance value of the driving channel 15 and the sensing channel 25 should not be increased. For this, in the touch panel 200, a width of a bridge 35 for connecting the sensing channels 25 and a width of a connecting portion of the driving channels 15 are made smaller than that of the sensing channel 25 and the driving channel 15, while a resistance value is prevented from increasing, a crossing area is reduced. That is, the touch panel 200 reduces a width of only a crossing portion of the driving channel 15 and the sensing channel 25.

When it is assumed that a width of the bridge 35 of the touch panel 200 is 75 μm and a width of a connecting portion thereof is 70 um, each crossing point of the touch panel 200 has an area of 5,250 um2 (=70*75). That is, when the touch panel 200 has the same dielectric constant, the touch panel 200 of FIG. 2 has a separation distance smaller by 1/762 (=5250 um²/4 mm²) times than that of the touch panel 100 of FIG. 1. However, as shown in FIG. 2, when reducing a crossing area by reducing a width of the bridge 35 and a width of the connecting portion, the touch panel 200 has a touch performance relatively lower than that of the touch panel 100 of FIG. 1 due to a narrow width.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a touch panel and a method of manufacturing the same that can reduce a thickness of a touch panel without deterioration of a touch performance by forming a driving channel and a sensing channel with a conductive mesh (e.g., a metal mesh) and that can simplify a production process.

An aspect of the present invention further provide a touch panel and a method of manufacturing the same having a flexible property and capable of being formed in a large size.

In accordance with an aspect of the present invention, a touch panel is provided. The touch panel includes a substrate in which a conductive mesh is disposed, a plurality of driving channels for recognizing a horizontal axis coordinate, wherein the plurality of driving channels are formed by patterning a first conductive mesh disposed at the substrate, a plurality of sensing channels for recognizing a vertical axis coordinate, wherein the plurality of sensing channels are formed by patterning a second conductive mesh disposed at the substrate, and an insulating layer positioned between the first conductive mesh and the second conductive mesh.

In accordance with another aspect of the present invention, a touch panel is provided. The touch panel includes a substrate in which a conductive mesh is disposed, a plurality of driving channels for recognizing a horizontal axis coordinate, wherein the plurality of driving channels are formed by patterning a first conductive mesh disposed on a first surface of the substrate, and a plurality of sensing channels for recognizing a vertical axis coordinate, wherein the plurality of sensing channels are formed by patterning a second conductive mesh disposed on a second surface, which is a surface opposite to the first surface of the substrate.

In accordance with another aspect of the present invention, a touch panel is provided. The touch panel includes a first substrate and a second substrate, a plurality of driving channels for recognizing a horizontal axis coordinate, wherein the plurality of driving channels are formed by patterning a first conductive mesh disposed on the first substrate, a plurality of sensing channels for recognizing a vertical axis coordinate, wherein the plurality of sensing channels are formed by patterning a second conductive mesh disposed on the second substrate, and a transparent adhesive for adhering the first substrate and the second substrate.

In accordance with another aspect of the present invention, a touch panel is provided. The touch panel includes a substrate, a plurality of driving channels for recognizing a horizontal axis coordinate, wherein the plurality of driving channels are formed by printing a first conductive mesh on the substrate, a plurality of sensing channels for recognizing a vertical axis coordinate, wherein the plurality of sensing channels are formed by printing a second conductive mesh on the substrate, and an insulating layer positioned between the first conductive mesh and the second conductive mesh.

In accordance with another aspect of the present invention, a method of manufacturing a touch panel is provided. The method includes coating a first conductive mesh on a substrate, patterning the first conductive mesh to correspond to a plurality of driving channels for recognizing a horizontal axis coordinate, coating an insulating layer on a substrate in which the plurality of driving channels are formed, coating a second conductive mesh on the substrate in which the insulating layer is coated, and patterning the second conductive mesh to correspond to a plurality of sensing channels for recognizing a vertical axis coordinate.

In accordance with another aspect of the present invention, a method of manufacturing a touch panel is provided. The method includes coating a first conductive mesh on a first surface of a substrate, patterning the first conductive mesh to correspond to a plurality of driving channels for recognizing a horizontal axis coordinate, coating a second conductive mesh on a second surface, which is a surface opposite to the first surface of the substrate, and patterning the second conductive mesh to correspond to a plurality of sensing channels for recognizing a vertical axis coordinate.

In accordance with another aspect of the present invention, a method of manufacturing a touch panel is provided. The method includes coating a first conductive mesh on a first substrate, patterning the first conductive mesh to correspond to a plurality of driving channels for recognizing a horizontal axis coordinate, coating a second conductive mesh on a second substrate, patterning the second conductive mesh to correspond to a plurality of sensing channels for recognizing a vertical axis coordinate, and adhering the patterned first and second substrates.

In accordance with another aspect of the present invention, a method of manufacturing a touch panel is provided. The method includes printing a first conductive mesh to correspond to a plurality of driving channels for recognizing a horizontal axis coordinate in a substrate, printing an insulating layer in a substrate in which the plurality of driving channels are printed, and printing a second conductive mesh to correspond to a plurality of sensing channels for recognizing a vertical axis coordinate in the substrate in which the insulating layer is printed.

As described above, in a touch panel and a method of manufacturing the same according to an exemplary embodiment of the present invention, by forming a driving channel and a sensing channel using a conductive mesh, a thickness of a touch panel can be reduced without deterioration of a touch performance.

Further, by forming a driving channel and a sensing channel using the conductive mesh, lower resistance than that of a related-art transparent electrode (e.g., ITO) can be obtained. Thereby, according to aspects of the present invention, a touch performance of a touch panel can be improved, and a large-sized touch panel can be produced.

Further, by simplifying a production process, a production cost of a touch panel can be reduced.

Further, as a conductive mesh is used, even if a touch panel is bent, a crack does not occur in a driving channel and a sensing channel and thus a flexible touch panel can be produced.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1 and 2 are diagrams illustrating a touch panel according to the related art;

FIG. 3 is a flowchart illustrating a process of manufacturing a touch panel according to an exemplary embodiment of the present invention;

FIGS. 4A and 4B are diagrams illustrating a process of manufacturing a touch panel according to a first exemplary embodiment of the present invention;

FIGS. 5A and 5B are diagrams illustrating a process of manufacturing a touch panel according to a second exemplary embodiment of the present invention;

FIG. 6 is a diagram illustrating a process of manufacturing a touch panel according to a third exemplary embodiment of the present invention; and

FIG. 7 is a diagram illustrating a process of manufacturing a touch panel according to a fourth exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, detailed descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While the present invention may be embodied in many different forms, specific exemplary embodiments of the present invention are shown in drawings and are described herein in detail, with the understanding that the present disclosure is to be considered as an exemplification of the principles of the invention and is not intended to limit the invention to the specific exemplary embodiments illustrated.

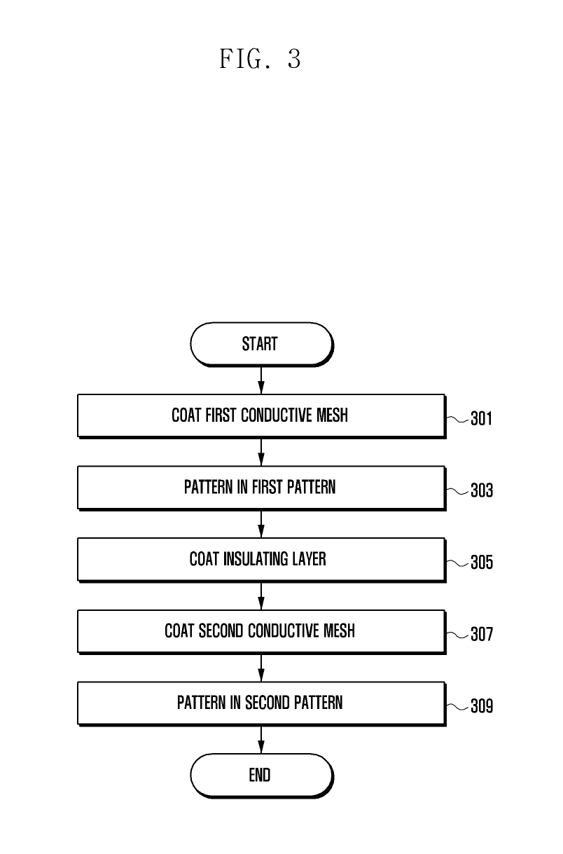

FIG. 3 is a flowchart illustrating a process of manufacturing a touch panel according to an exemplary embodiment of the present invention.

Referring to FIG. 3, in a process of manufacturing a touch panel according to the present exemplary embodiment, a first conductive mesh is coated on a substrate in step 301. The first conductive mesh is made of a metal material such as copper, silver, and aluminum. In this case, the first conductive mesh may have a line width of several μm (e.g., 5 μm). Further, by applying darkening technology and a mesh chemical processing to the conductive mesh, performance deterioration according to a change of a temperature and humidity is minimized.

The substrate is a constituent element to be a base that can coat a sensing channel and a driving channel formed with a conductive mesh. When a touch panel is used for a touch screen, the substrate may be a transparent substrate, and when the touch panel is used for a touch pad, the substrate may be an opaque substrate. When the touch panel is applied to a flexible touch screen, the substrate is made of a flexible material. Further, the substrate is changed according to a production method of the touch panel. For example, the substrate may be formed with a protection window, display panel, polarizer, and Polyethylene Terephthalate (PET) film. This will be described in detail later.

Next, the first conductive mesh is patterned in a first pattern in step 303. For example, a first conductive mesh coated on the substrate may be patterned in a first pattern using a photo process. In this case, the first pattern may be a pattern corresponding to a plurality of driving channels for recognizing a horizontal axis coordinate.

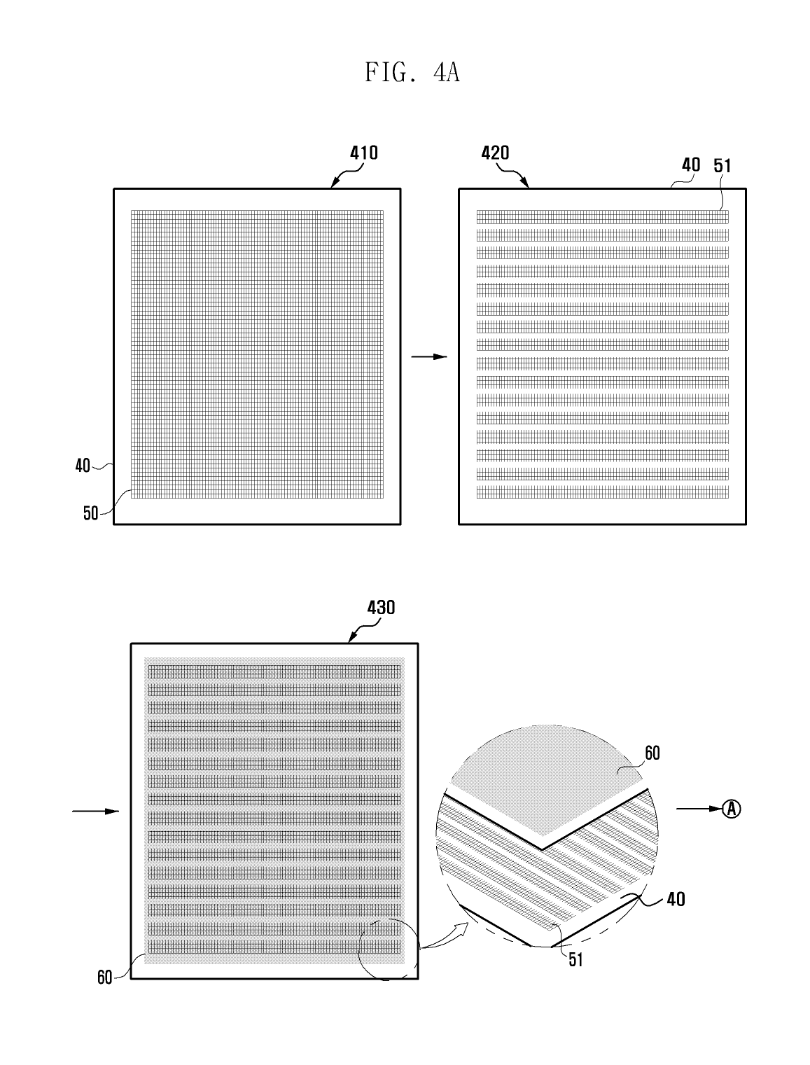

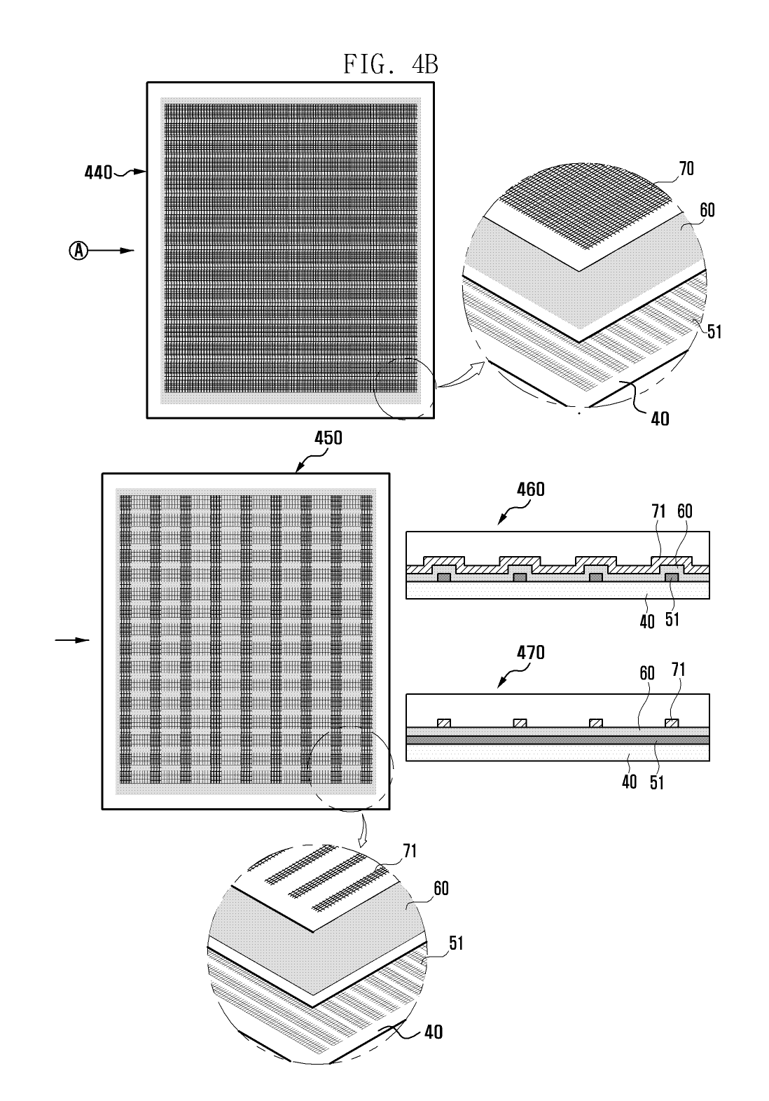

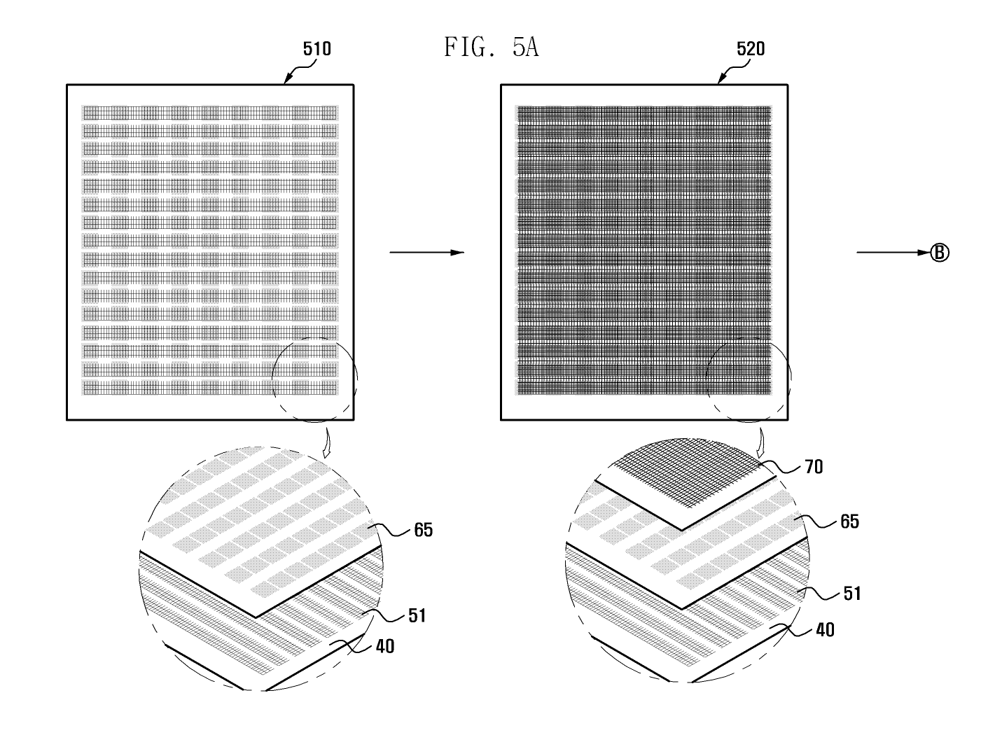

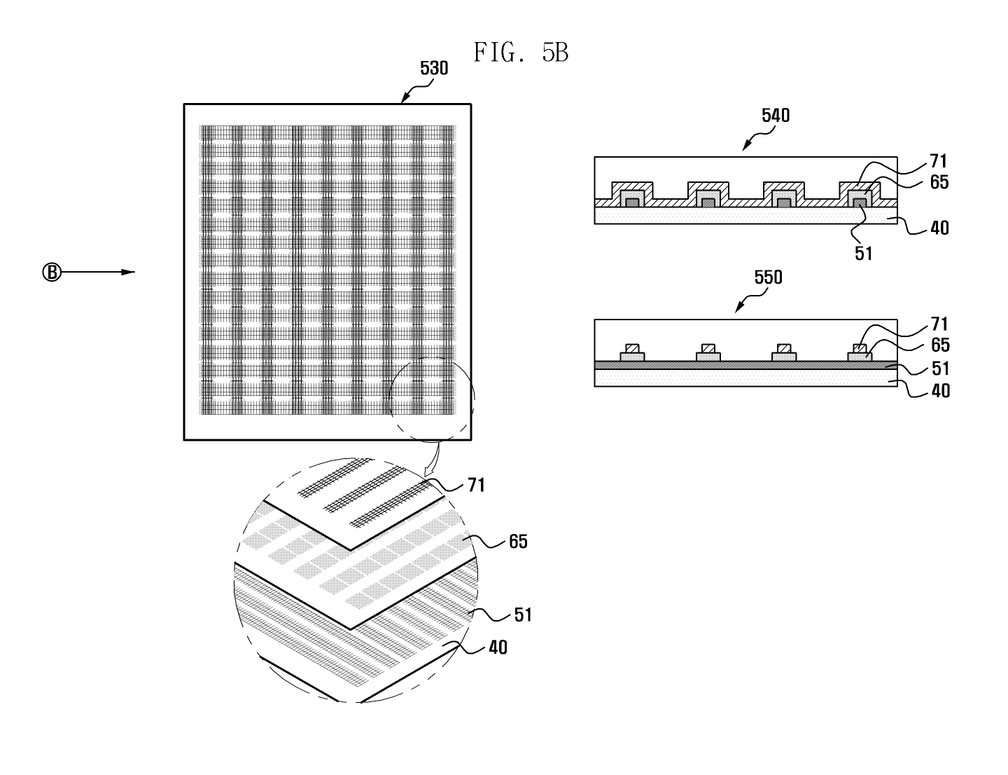

When patterning of the first conductive mesh is complete, an insulating layer is coated in step 305. In this case, the insulating layer is coated on an entire area in which the first conductive mesh is coated (see FIGS. 4A and 4B to be described later) or only at an area in which the driving channel and a sensing channel formed with a second conductive mesh are overlapped (see FIGS. 5A and 5B to be described later).

When coating of the insulating layer is complete, a second conductive mesh is coated in step 307. The second conductive mesh has the same configuration as that of the first conductive mesh. Therefore, a detailed description thereof is omitted. When coating of the second conductive mesh is complete, the second conductive mesh is patterned in a second pattern in step 309. The second pattern may be a pattern corresponding to a plurality of sensing channels for recognizing a vertical axis coordinate.

Steps 301 and 303 may be performed with one process. That is, a conductive mesh may be printed to have a first pattern on the substrate. Similarly, steps 307 and 309 may be performed with one process. The insulating layer may be also stacked on the substrate using a printing method.

Further, although not shown in FIG. 3, in order to protect the second pattern, a process of manufacturing a touch panel according to the present exemplary embodiment may further include the step of printing or coating a protective layer or stacking a protection substrate.

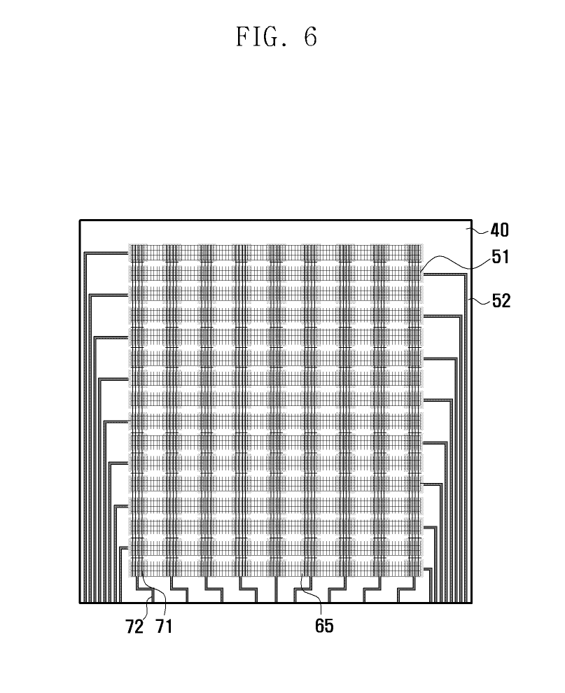

Further, the first pattern may include a plurality of first wirings connected to a plurality of driving channels, respectively, and for transmitting a touch signal sensed by a driving channel to a touch processor (e.g., a touch driver IC). That is, in another exemplary embodiment of the present invention, when patterning the first conductive mesh, a driving channel and a first wiring connected to the driving channel may be simultaneously patterned. Similarly, the second pattern may be connected to a plurality of sensing channels, and a plurality of second wirings for transmitting a touch signal sensed by the sensing channel to a touch processor may be included. That is, in another exemplary embodiment of the present invention, when patterning a second conductive mesh, a sensing channel and a second wiring connected to the sensing channel may be simultaneously patterned. A detailed description thereof will be described later with reference to FIG. 6.

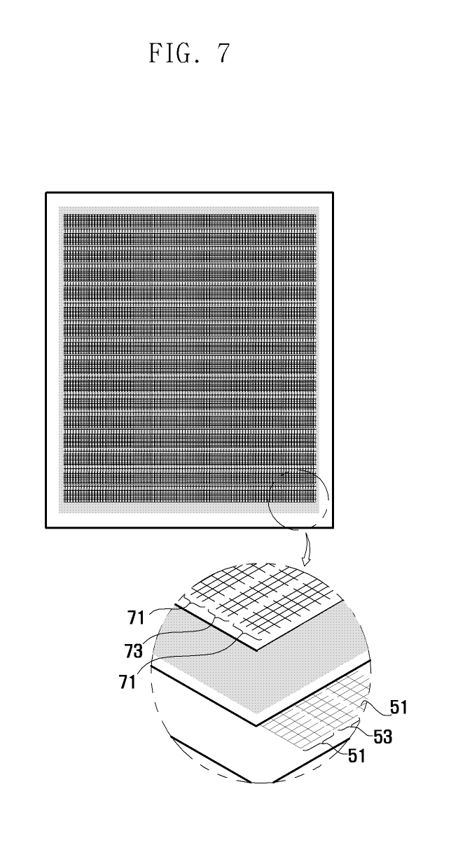

Further, in the foregoing description, it was described that patterning is performed to correspond to a driving channel and a sensing channel, but the aspects of the present invention are not limited thereto. For example, in another exemplary embodiment of the present invention, an entire conductive mesh positioned between a driving channel and a sensing channel is not removed and only a partial conductive mesh may be removed. This is to improve visibility. A detailed description thereof will be described later with reference to FIG. 7.

Further, in the foregoing description, it was described that a driving channel and a sensing channel are coated on the same surface of the substrate, but the present invention is not limited thereto. For example, the sensing channel may be coated on one surface (e.g., a front surface) of the substrate, and the driving channel may be coated on an opposite surface (e.g., a rear surface) of the substrate.

Further, in the foregoing description, it was described that a driving channel and a sensing channel are coated on one substrate, but the aspects of the present invention are not limited thereto. That is, in another example of the present invention, the driving channel and the sensing channel may each be formed in different substrates. For example, in the present exemplary embodiment, after the sensing channel is coated on a first substrate and the driving channel is coated on a second substrate, the first substrate and the second substrate may be adhered using a transparent adhesive.

FIGS. 4A and 4B are diagrams illustrating a process of manufacturing a touch panel according to a first exemplary embodiment of the present invention.

Referring to FIGS. 4A and 4B, in a method of manufacturing a touch panel according to the first exemplary embodiment of the present invention, as shown in the drawing of reference numeral 410, a first conductive mesh 50 is coated on a substrate 40. The substrate 40 may include a touch area in which a driving channel and a sensing channel for sensing a touch are coated and a wiring area in which wirings for transmitting a touch signal sensed through the driving channel and the sensing channel to a touch processor (e.g., a touch driver IC) are coated. In this case, the first conductive mesh 50 may be coated in a touch area or an entire area of the substrate 40. The substrate 40 may be a display panel such as a protection window, a Liquid Crystal Display (LCD), and an Organic Light Emitting Diode (OLED), a polarizer or a PET film made of a glass, Poly Carbonate (PC), or Poly Methyl Methacrylate (PMMA) material that may coat a conductive mesh. FIGS. 4A and 4B illustrate the first conductive mesh 50 having a quadrangular structure, however the aspects of the present invention are not limited thereto. For example, the first conductive mesh 50 may have a structure of a lozenge, hive, and nano wire. The first conductive mesh 50 is made of a metal material such as copper, silver, and aluminum. In this case, it is preferable, but not necessary, that a line width of the first conductive mesh 50 is reduced to several μm (e.g., 5 μm) and the first conductive mesh 50 is not viewed by a user using darkening technology and a mesh chemical processing, and performance deterioration according to a change of temperature and humidity is minimized. Unlike a related-art ITO, even if the conductive mesh is bent, a crack does not occur. Thereby, a touch panel of the present exemplary embodiment is formed to have a flexible property.

Next, as indicated by reference numeral 420, the first conductive mesh 50 is patterned to have a first pattern corresponding to a plurality of driving channels 51 for recognizing a horizontal axis coordinate. The first conductive mesh 50 is patterned to have a first pattern through a photo process.

When patterning of the first conductive mesh 50 is complete, as indicated by reference numeral 430, an insulating layer 60 is coated. In this case, the insulating layer 60 is coated to cover the entire plurality of driving channels 51. In an enlarged view of the reference numeral 430, the first conductive mesh 50 and the insulating layer 60 are separated, however this is for convenience of description, and the first conductive mesh 50 and the insulating layer 60 are actually sequentially stacked on the substrate 40.

When coating of the insulating layer 60 is complete, as indicated by reference numeral 440, a second conductive mesh 70 is coated in a touch area or an entire area of the substrate 40. In an enlarged view of the reference numeral 440, the plurality of driving channels 51, the insulating layer 60, and the second conductive mesh 70 are separated, however the plurality of driving channels 51, the insulating layer 60, and the second conductive mesh 70 are actually sequentially stacked on the substrate 40.

When coating of the second conductive mesh 70 is complete, as indicated by reference numeral 450, the second conductive mesh 70 is pattered to have a second pattern corresponding to a plurality of sensing channels for recognizing a vertical axis coordinate. In an enlarged view of the reference numeral 450, a plurality of driving channels 51, an insulating layer 60, and a plurality of sensing channels 71 are separated, however as shown in a cross-sectional view of reference numeral 460 and reference numeral 470, the plurality of driving channels 51, the insulating layer 60, and the plurality of sensing channels 71 are actually sequentially stacked on the substrate 40. In this case, the drawing of the reference numeral 460 is a cross-sectional view of a touch panel taken in a vertical direction, and the drawing of reference numeral 470 is a cross-sectional view of a touch panel taken in a horizontal direction. That is, a touch panel according to a first exemplary embodiment of the present invention includes the substrate 40 that can coat a conductive mesh, the first conductive mesh 50 coated in the substrate and patterned to have a first pattern corresponding to the driving channel 51, the second conductive mesh 70 coated at the substrate 40 and patterned to have a second pattern corresponding to the sensing channel 71, and the insulating layer 60 positioned between the first conductive mesh 50 and the second conductive mesh 70.

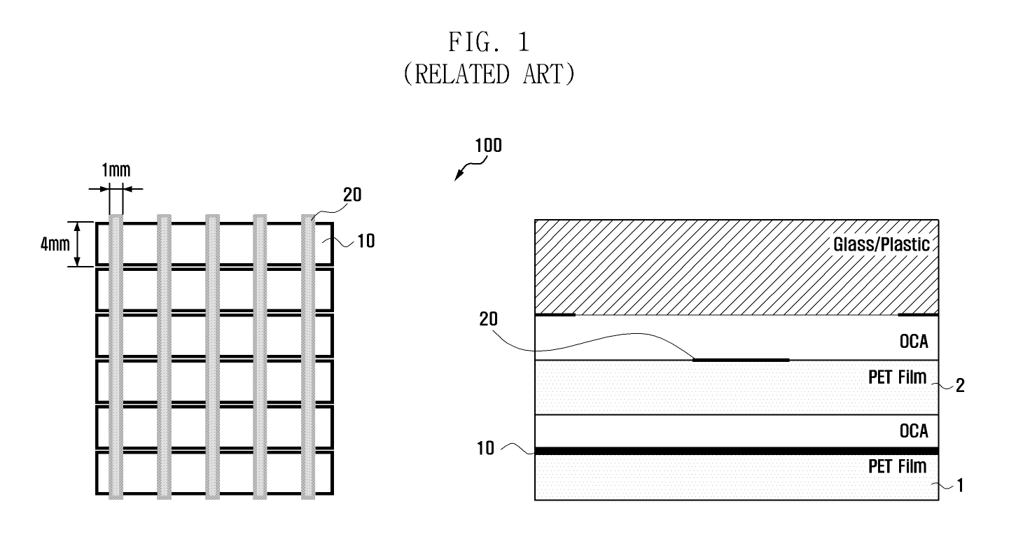

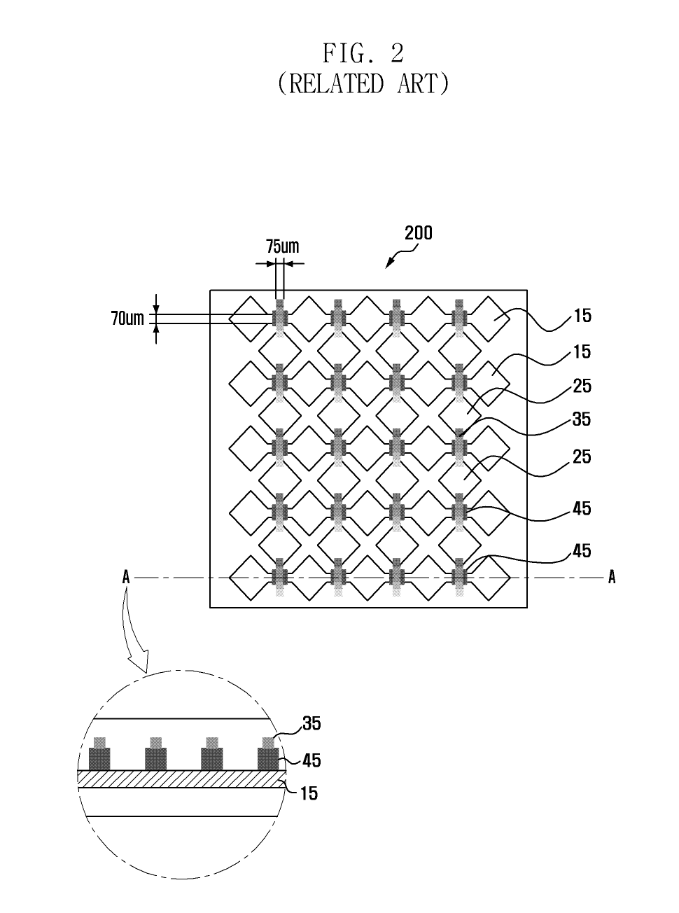

As shown in the drawing of the reference numeral 450, the driving channel 51 and the sensing channel 71 include a plurality of mesh lines and are crossed at a plurality of points. In this case, when it is assumed that the mesh number of the driving channel 51 is 20, the mesh number of the sensing channel 71 is 10, and a line width of each mesh is 5 μm, an area of each crossing point may be 5,000 um2=(20*5)*(10*5). That is, it can be seen that an area of a crossing point of a touch panel of the present exemplary embodiment has a value similar to a crossing area (5,250 um2) of the related-art touch panel 200 having a 1-layer double pattern structure of FIG. 2. Therefore, in the present exemplary embodiment, a touch panel may be produced so that the driving channel 51 and the sensing channel 71 have a separation distance of tens nm to several μm. Particularly, in the present exemplary embodiment, instead of forming the driving channel 51 and the sensing channel 71 with ITO having relatively large resistivity (intrinsic resistance) like a related-art touch panel, by forming the driving channel 51 and the sensing channel 71 with a conductive mesh of a metal material having relatively small resistivity, a separation distance can be remarkably reduced, compared with a case of FIG. 1, and only a width of a crossing point may not be reduced, like the related-art touch panel 200 of FIG. 2.

FIGS. 5A and 5B are diagrams illustrating a process of manufacturing a touch panel according to a second exemplary embodiment of the present invention.

Referring to FIGS. 5A and 5B, in a process of providing a touch panel according to a second exemplary embodiment of the present invention, in a touch area or an entire area of a substrate 40, a first conductive mesh is coated, and the coated first conductive mesh is patterned in a first pattern to correspond to a plurality of driving channels for recognizing a horizontal axis coordinate. That is, in a process of providing a touch panel according to a second exemplary embodiment of the present invention, a driving channel 51 is formed through the same process as processes 410 and 420 of FIG. 4.

Next, as indicated by reference numeral 510, an insulating layer 65 is coated. In this case, in order to prevent the driving channel 51 and the sensing channel 71 from electrically contacting, the insulating layer 65 is coated only at a crossing area of the driving channel 51 and the sensing channel 71. When coating of the insulating layer 65 is complete, in the present exemplary embodiment, as indicated by reference numeral 520, a second conductive mesh 70 is coated on the substrate 40 in which the insulating layer 65 is coated. In an enlarged view of reference numeral 520, the plurality of driving channels 51, the insulating layer 65, and the second conductive mesh 70 are separated, but are actually sequentially stacked on the substrate 40.

When coating of the second conductive mesh 70 is complete, in the present exemplary embodiment, as indicated by reference numeral 530, the second conductive mesh 70 is pattered in a second pattern to correspond to a plurality of sensing channels for recognizing a vertical axis coordinate. In an enlarged view of reference numeral 530, the plurality of driving channels 51, the insulating layer 65, and the plurality of sensing channels 71 are separated, but as shown in a cross-sectional view of reference numerals 540 and 550, the plurality of driving channels 51, the insulating layer 65, and the plurality of sensing channels 71 are actually sequentially stacked on the substrate 40. Here, the drawing of the reference numeral 540 is a cross-sectional view of a touch panel taken in a vertical direction, and the drawing of reference numeral 550 is a cross-sectional view of a touch panel taken in a horizontal direction. A process of manufacturing a touch panel according to the second exemplary embodiment of the present invention is the same as that of the first exemplary embodiment described with reference to FIGS. 4A and 4B, except for a difference in which an insulating layer is coated only at an area in which a driving channel and a sensing channel are overlapped.

FIG. 6 is a diagram illustrating a process of manufacturing a touch panel according to a third exemplary embodiment of the present invention.

Referring to FIG. 6, in a third exemplary embodiment of the present invention, when patterning a first conductive mesh 50 and a second conductive mesh 70, a wiring for transmitting a touch signal sensed through a driving channel and a sensing channel to a touch processor is together patterned. That is, in the related art, a process of forming a wiring was separately performed. However, in a third exemplary embodiment of the present invention, after the first conductive mesh 50 is coated at an entire wiring area and a touch area of a substrate 40, in a patterning process of the first conductive mesh 50, the first conductive mesh 50 may be patterned to have a pattern corresponding to a driving channel 51 and a plurality of first wirings 52 for transmitting a touch signal of the driving channel 51 to a touch processor (touch driver IC). Similarly, after coating the second conductive mesh 70 on an entire wiring area and a touch area of the substrate 40, in a patterning process of a sensing channel 71, the second conductive mesh 70 may be patterned to have a pattern corresponding to the sensing channel 71 and a plurality of second wirings 72 for transmitting a touch signal of the sensing channel 71 to a touch processor (touch driver IC).

In this case, a line width of a conductive mesh forming the driving channel 51 and the sensing channel 71 and a line width of a conductive mesh forming the first wiring 52 and the second wiring 72 are different. That is, because the first wiring 52 and the second wiring 72 are positioned at an area not exposed to a user, it is unnecessary to thinly form a line width. Therefore, a line width (e.g., 100 um) of the first wiring 52 and the second wiring 72 may be formed larger than a line width (e.g., 5 um) of the driving channel 51 and the sensing channel 71. This is to make a resistance value of the first wiring 52 and the second wiring 72 to be low.

Here, in an entire production process of a touch panel according to a third exemplary embodiment of the present invention, the first conductive mesh 50 is coated on a touch area and a wiring area of the substrate 40. When coating of the first conductive mesh 50 is complete, the first conductive mesh 50 is patterned to have a pattern corresponding to the driving channel 51 and the first wiring 52. Next, in the present exemplary embodiment, the insulating layer 65 is coated. FIG. 6 illustrates that the insulating layer 65 is coated only at an area in which the driving channel and the sensing channel are overlapped, as shown in the second exemplary embodiment, but the insulating layer may be coated at a touch area or an entire area of the substrate 40, as shown in the foregoing first exemplary embodiment.

When coating of the insulating layer 65 is complete, the second conductive mesh 70 is coated, and the second conductive mesh 70 is patterned to have a pattern corresponding to the sensing channel 71 and the second wiring 72.

FIG. 7 is a diagram illustrating a process of manufacturing a touch panel according to a fourth exemplary embodiment of the present invention.

Referring to FIG. 7, when an empty space exists between driving channels 51 and sensing channels 71, as in the first exemplary embodiment to the third exemplary embodiment, the fourth exemplary embodiment of the present invention solves a visibility problem that the driving channel 51 and the sensing channel 71 are viewed to a user. Specifically, when patterning a first conductive mesh 50 in a first pattern, instead of removing an entire conductive mesh 53 of an area other than the driving channel 51, as in the first exemplary embodiment to the third exemplary embodiment of the present invention, as shown in an enlarged view of FIG. 7, only a minimum conductive mesh may be removed so that a conductive mesh constituting the driving channel 51 and the conductive mesh 53 (first auxiliary mesh) not constituting the driving channel 51 are not electrically connected. For example, instead of removing entire conductive meshes (including a plurality of mesh lines) positioned between the driving channels 51, only at least one mesh line adjacent to the driving channel 51 may be removed. Similarly, when patterning a second conductive mesh 70 in a second pattern, a conductive mesh of an area other than the sensing channel 71 is entirely removed, and as shown in an enlarged view of FIG. 7, only a minimum conductive mesh may be removed so that a conductive mesh constituting the sensing channel 71 and a conductive mesh 73 (second auxiliary mesh) not constituting the sensing channel 71 are not electrically connected.

In FIG. 7, in a plurality of mesh lines included in a conductive mesh not constituting the driving channel 51 and the sensing channel 71, only a mesh line most adjacent to the driving channel 51 and the sensing channel 71 is removed, however the present invention is not limited thereto. That is, in another exemplary embodiment of the present invention, a mesh line may be removed to have a specific pattern. For example, a first mesh line is removed to ⅓ point from one side end point of the driving channel 51 or the sensing channel 71, a second mesh line is removed from ⅓ point to ⅔ point, and a first mesh line may be removed from ⅔ point to the other side end point. In this case, the number of the removed mesh lines and a removed pattern form may be variously changed in consideration of a touch performance and visibility. Although not shown in FIGS. 4A to 7, a process of manufacturing a touch panel according to the present exemplary embodiment may further include the step of printing or coating a protective layer, or stacking a protection substrate in order to protect the sensing channel.

Accordingly, as the touch panel according to an exemplary embodiment of the present invention forms a driving channel and a sensing channel of the touch panel using a conductive mesh, a crossing area of the driving channel and the sensing channel can be reduced. Thereby, according to aspects of the present invention, a distance between a driving channel and a sensing channel can be reduced. That is, a thickness of the touch panel can be reduced without deterioration of a touch performance.

Further, the aspects of the present invention can be applied to a method of manufacturing various touch panels. For example, the aspects of the present invention may be applied to a method of stacking a first conductive mesh, insulating layer, and second conductive mesh in a PET film positioned between a display panel and a protection window, a method of stacking a first conductive mesh, insulating layer, and second conductive mesh in a protection window, and a method of stacking a first conductive mesh, insulating layer, and second conductive mesh in a display panel (an upper end portion of a display or a lower end portion of a polarizer). Further, according to the aspects of the present invention a sensing channel using a conductive mesh may be formed at one surface of a substrate and a driving channel using a conductive mesh may be formed at the other surface (opposite surface) of a substrate. In this case, a separate insulating layer may not be included. In this case, the substrate may have a thickness of several μm to hundreds μm. Alternatively, after forming a driving channel in a first substrate and forming a sensing channel in a second substrate, the first substrate and the second substrate may be adhered using a transparent adhesive. In this case, by adhering the first substrate and the second substrate so that the driving channel and the sensing channel are opposite, the driving channel and the sensing channel can be protected. In this case, the transparent adhesive may be made of an insulation material. The first substrate, second substrate, and transparent adhesive may have a thickness of several μm to hundreds μm.

Further, aspects of the present invention may be applied to a protection window in which deco is printed. Particularly, aspects of the present invention may be applied even to a protection window that prints white deco. Specifically, when using a transparent electrode (ITO), in a method of manufacturing a related-art touch panel, for deposition of ITO, a process is performed at a high temperature, and when deco is printed with a white color, a problem that a color of deco is deteriorated existed. However, according to aspects of the present invention, by using a method of coating a conductive mesh, a process is performed at a relatively lower temperature. Thereby, the aspects of the present invention can be applied to even when manufacturing a touch panel using a protection window in which white deco is printed.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch panel comprising:
a substrate in which a conductive mesh is disposed;
a plurality of driving channels for recognizing a horizontal axis coordinate, wherein the plurality of driving channels are formed by patterning a first conductive mesh disposed on the substrate;
a plurality of sensing channels for recognizing a vertical axis coordinate, wherein the plurality of sensing channels are formed by patterning a second conductive mesh disposed on the substrate; and
an insulating layer positioned between the first conductive mesh and the second conductive mesh.

2. The touch panel of claim 1, wherein the insulating layer is coated only at an area in which the plurality of driving channels and the plurality of sensing channels overlap or is coated on an entire area of the plurality of driving channels.

3. The touch panel of claim 1, further comprising:
a first auxiliary mesh formed between the plurality of driving channels to be electrically separated from the plurality of driving channels; and
a second auxiliary mesh formed between the plurality of sensing channels to be electrically separated from the plurality of sensing channels.

4. The touch panel of claim 1, further comprising:
a first wiring connected to the plurality of driving channels and for transmitting a touch signal sensed by each driving channel to a touch processor; and
a second wiring connected to the plurality of sensing channels and for transmitting a touch signal sensed by each sensing channel to the touch processor.

5. The touch panel of claim 1, further comprising a protective layer or a protection substrate for protecting the second channels.

6. The touch panel of claim 1, wherein the substrate comprises a protection window, display panel, polarizer, and polyethylene terephthalate film.

7. The touch panel of claim 6, wherein in the protection window, deco is printed.

8. The touch panel of claim 1, wherein the first conductive mesh and the second conductive mesh are made of a metal material.

9. The touch panel of claim 1, wherein the touch panel is flexible.

10. The touch panel of claim 4, wherein the first wiring and the second wiring have a line width larger than that of a conductive mesh constituting a driving channel and a sensing channel.

11. A method of manufacturing a touch panel, the method comprising:
coating a first conductive mesh on a substrate;
patterning the first conductive mesh to correspond to a plurality of driving channels for recognizing a horizontal axis coordinate;
coating an insulating layer on a substrate in which the plurality of driving channels are formed;
coating a second conductive mesh on the substrate in which the insulating layer is coated; and
patterning the second conductive mesh to correspond to a plurality of sensing channels for recognizing a vertical axis coordinate.

12. The method of claim 11, wherein the coating of the insulating layer on the substrate on which the plurality of driving channels are formed comprises coating the insulating layer on an entire area on which the plurality of driving channels are positioned or on an area on which the plurality of driving channels and the plurality of the sensing channels overlap.

13. The method of claim 11, wherein the patterning of the first conductive mesh to correspond to the plurality of driving channels for recognizing the horizontal axis coordinate comprises patterning a first auxiliary mesh formed between the plurality of driving channels to be electrically separated from the plurality of driving channels.

14. The method of claim 11, wherein the patterning of the second conductive mesh to correspond to the plurality of sensing channels for recognizing the vertical axis coordinate comprises patterning a second auxiliary mesh positioned between the plurality of sensing channels to be electrically separated from the plurality of sensing channels.

15. The method of claim 11, wherein the patterning of the first conductive mesh to correspond to the plurality of driving channels for recognizing the horizontal axis coordinate comprises patterning a first wiring connected to the plurality of driving channels for transmitting a touch signal sensed by each driving channel to a touch processor.

16. The method of claim 11, wherein the patterning of the second conductive mesh to correspond to the plurality of sensing channels for recognizing the vertical axis coordinate comprises patterning a second wiring connected to the plurality of sensing channels for transmitting a touch signal sensed by each sensing channel to a touch processor.

17. The method of claim 11, further comprising at least one of:
printing or coating a protective layer for protecting the plurality of sensing channels; and
stacking a protection substrate for protecting the plurality of sensing channels.

18. The method of claim 11, wherein the coating of the first conductive mesh on the substrate comprises one of:
coating the first conductive mesh at a protection window;
coating the first conductive mesh at a display panel;
coating the first conductive mesh at a polarizer; and
coating the first conductive mesh at a separate polyethylene terephthalate film.

19. The method of claim 18, wherein in the protection window, deco is printed.

20. The method of claim 11, wherein the first conductive mesh and the second conductive are made of a metal material.

21. A touch panel comprising:
a first substrate and a second substrate;
a plurality of driving channels for recognizing a horizontal axis coordinate, wherein the plurality of driving channels are formed by patterning a first conductive mesh disposed on the first substrate;
a plurality of sensing channels for recognizing a vertical axis coordinate, wherein the plurality of sensing channels are formed by patterning a second conductive mesh disposed on the second substrate; and
a transparent adhesive for adhering the first substrate and the second substrate.
